(19) United States
(12) Patent Application Publication
(10) Pub. No.: US 2026/0197242 A1
(43) Pub. Date: Jul. 9, 2026

(54) NETWORK PLANNING THROUGH NETWORK-DEMAND FORECASTING AND SIMULATION

(71) Applicant: Charter Communications Operating, LLC, St. Louis, MO (US)

(72) Inventors: Jairo Andres Ramos, Washington, DC (US); Cameron Daniel Severn, Aurora, CO (US)

(21) Appl. No.: 19/009,418

(22) Filed: Jan. 3, 2025

(51) Int. Cl. H04L 41/14; H04L 41/147

(52) U.S. Cl. CPC H04L 41/145; H04L 41/147

(57) ABSTRACT

A computing system configured to perform network-forecasting operations is provided. The computing system is configured to obtain a plurality of simulation parameters that identify at least one service group of a plurality of service groups serviced by the computing system, obtain network data associated with the computing system based on the plurality of simulation parameters, determine a projected network utilization that characterizes a forecasted network capacity for the at least one service group based on the plurality of simulation parameters and the network data, and generate a network upgrade for the at least one service group based on the projected network utilization and the plurality of simulation parameters. The network upgrade is configured to provide the forecasted network capacity to the at least one service group.

### BACKGROUND

A service group of cable modems share the same service group bandwidth and at times, if sufficient numbers of cable modems in the service group are all actively downloading data, the bandwidth demand may exceed the maximum bandwidth of the service group resulting in one or more of the cable modems incapable of obtaining the bandwidth for which the subscriber has paid.

### SUMMARY

The examples disclosed herein implement network-forecasting mechanisms and frameworks for generating model-based network upgrades based on network-utilization projections for services groups.

In one implementation, a method is provided. The method includes obtaining, by a computing system, a plurality of simulation parameters, the plurality of simulation parameters identifying at least one service group of a plurality of service groups serviced by the computing system. The method further includes obtaining, by the computing system, network data associated with the computing system based on the plurality of simulation parameters. The method further includes determining, by the computing system, a projected network utilization for the at least one service group based on the plurality of simulation parameters and the network data, the projected network utilization characterizing a forecasted network capacity for the at least one service group. The method further includes generating, by the computing system, a network upgrade for the at least one service group based on the projected network utilization and the plurality of simulation parameters, the network upgrade configured to provide the forecasted network capacity to the at least one service group.

In another implementation, a computing system is provided. The computing system includes one or more computing devices. The one or more computing devices are operable to obtain a plurality of simulation parameters, the plurality of simulation parameters identifying at least one service group of a plurality of service groups serviced by the computing system. The one or more computing devices are further operable to obtain network data associated with the computing system based on the plurality of simulation parameters. The one or more computing devices are further operable to determine a projected network utilization for the at least one service group based on the plurality of simulation parameters and the network data, the projected network utilization characterizing a forecasted network capacity for the at least one service group. The one or more computing devices are further operable to generate a network upgrade for the at least one service group based on the projected network utilization and the plurality of simulation parameters, the network upgrade configured to provide the forecasted network capacity to the at least one service group.

In another implementation, a non-transitory computer-readable medium is provided. The non-transitory computing-readable medium includes executable instructions configured to cause a processor device of a computing system to obtain a plurality of simulation parameters, the plurality of simulation parameters identifying at least one service group of a plurality of service groups serviced by the computing system. The executable instructions are further configured to cause the processor device of the computing system to obtain network data associated with the computing system based on the plurality of simulation parameters. The executable instructions are further configured to cause the processor device of the computing system to determine a projected network utilization for the at least one service group based on the plurality of simulation parameters and the network data, the projected network utilization characterizing a forecasted network capacity for the at least one service group. The executable instructions are further configured to cause the processor device of the computing system to generate a network upgrade for the at least one service group based on the projected network utilization and the plurality of simulation parameters, the network upgrade configured to provide the forecasted network capacity to the at least one service group.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram suitable for implementing network-forecasting operations according to some implementations;

FIG. 2 is a process flow diagram of an example framework for implementing network-forecasting operations according to some implementations;

FIG. 3 is a flowchart of an example network-forecasting method according to some implementations; and

FIG. 4 is a block diagram of a computing device of an example computing system suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A single aggregation device, such as a cable modem termination system (CMTS), provides services to many cable modems, such as tens of thousands of cable modems. Cable modems are organized into service groups wherein each cable modem in a service group is serviced by the same channel or channels and thus shares the aggregate bandwidth of the service group. An aggregation device may implement a plurality of service groups. A service group has a maximum bandwidth that is shared by all the cable modems in the service group. For purposes of brevity, the cable modems serviced by a service group may sometimes be referred to herein as the group of cable modems “in” the service group.

Cable modems in the same service group are often provisioned with different service (e.g., speed) tiers based on a pricing structure. Thus, for example, a subset of cable modems in a service group may be provisioned with a 1 Gbps service tier, meaning that the subset of cable modems should be able to achieve a 1 Gbps data transfer rate upon request, another subset of cable modems in the service group may be provisioned with a 600 Mbps service tier, and another subset of cable modems in the service group may be provisioned with a 200 Mbps service tier.

Changes to a service group to increase capacity or change (e.g., reduce) the group of cable modems serviced by the service group require physical changes to hardware. Accordingly, a technician must be dispatched to one or more locations if such a change to a service group is desired. This process is relatively costly and time-consuming, and thus it is preferable to change a service group only when necessary to provide adequate service to the group of cable modems in the service group. However, determining what may constitute adequate service—especially when planning for some point in the future—is particularly difficult, because effectively planning future network-infrastructure investments and/or upgrades requires estimating future customer demand for network capacity. Put differently, to plan and deploy network infrastructure upgrades based on uncertain future network utilizations, service providers must consider a number of different scenarios that reflect the numerous potential constraints, contingencies, patterns of customer behavior, etc. that may arise at some point in the future.

For instance, some service providers make future network utilization projections based on relatively simple compound annual growth rate (CAGR) models that rely on hypothetical estimates of network utilization changes over time. However, making costly and time-consuming network infrastructure upgrades based on such frameworks (e.g., CAGR models) is inherently risky for a number of reasons. For instance, CAGR models rely on a constant growth rate and, as such, fail to consider the impact of market externalities and changes in customer behavior (e.g., customer attrition, seasonality, etc.). Put simply, CAGR-based models require an over-simplification of complex market dynamics, which drastically reduces the predictive power of such models.

To address the aforementioned concerns, the examples disclosed herein implement mechanisms that leverage machine-learned models to generate sophisticated, accurate, customizable, and data-driven network utilization projections and corresponding network upgrade recommendations. As discussed in greater detail below, the present disclosure provides a computing system that is operable determine a projected network utilization that characterizes a forecasted network capacity for at least one service group based on a plurality of simulation parameters (e.g., obtained from a user) and internal network data associated with the computing system. Based on the projected network utilization, the computing system is further operable to generate a network upgrade for the at least one service group that is configured to provide the forecasted network capacity to the at least one service group.

As a general, non-limiting illustrative example, an example computing system of the present disclosure is configured to perform network-usage simulations in the form of discrete scenarios, which are based on a plurality of simulation parameters that define the scope of the desired simulation, as well as the constraints and contingencies that are to be considered. Upon obtaining the plurality of simulation parameters (e.g., from a user), the computing system may query recent network-level data to determine current utilization levels, current network capacity, etc. for each service group identified by the plurality of simulation parameters. The computing system may then determine a projected network utilization over a simulation time period and, based on the projected network utilization, generate a set of network upgrades that minimize costs given the specified constraints (e.g., in the plurality of simulation parameters). The network upgrades may include and/or identify, for each service group, the types of network upgrades that are needed, as well as when the upgrades should be deployed.

Those having ordinary skill in the art will appreciate that producing successful machine-learned models generally involves conducting extensive “ETL” (i.e., “Extract, Transform, Load”) operations, setting up specialized computing environments, conducting extensive model training, and/or the like. As such, incorporating flexible machine-learned models as part of iterated customizable network simulations is computationally costly and time consuming, thereby posing a number of non-trivial technical problems.

The present disclosure addresses these problems through a number of technical solutions that provide a number of technical effects and benefits. As one example, the present disclosure abstracts away boiler plate and other training processes, which reduces the challenges associated with producing robust time-series-based predictions. In fact, the present disclosure provides a framework that is operable to produce reasonable predictions with limited and/or missing training data, thereby reducing the need for extensive data processing. Furthermore, by implementing a hierarchical forecasting algorithm, the present disclosure is configured to generate network utilization projections and corresponding network upgrade recommendations for lower-level network units (e.g., service groups) based on models that are fit at the higher of aggregation within which the lower-level network units are nested (e.g., cable modem termination systems (CMTSs), designated market areas (DMAs), etc.). Because the higher-level data (e.g., associated with the aggregation devices) is less noisy than the lower-level data (e.g., associated with a service group), the present disclosure may generate network utilization projections and corresponding network upgrade recommendations for lower-level network units with noisy, limited, and/or no prior data, thereby reducing the computational load associated with model fitting. Additionally, the computing system of the present disclosure may be configured to leverage distributed computing architectures to train and run a plurality of machine-learned models in parallel, which likewise reduces the computational load and model-training times by orders of magnitude.

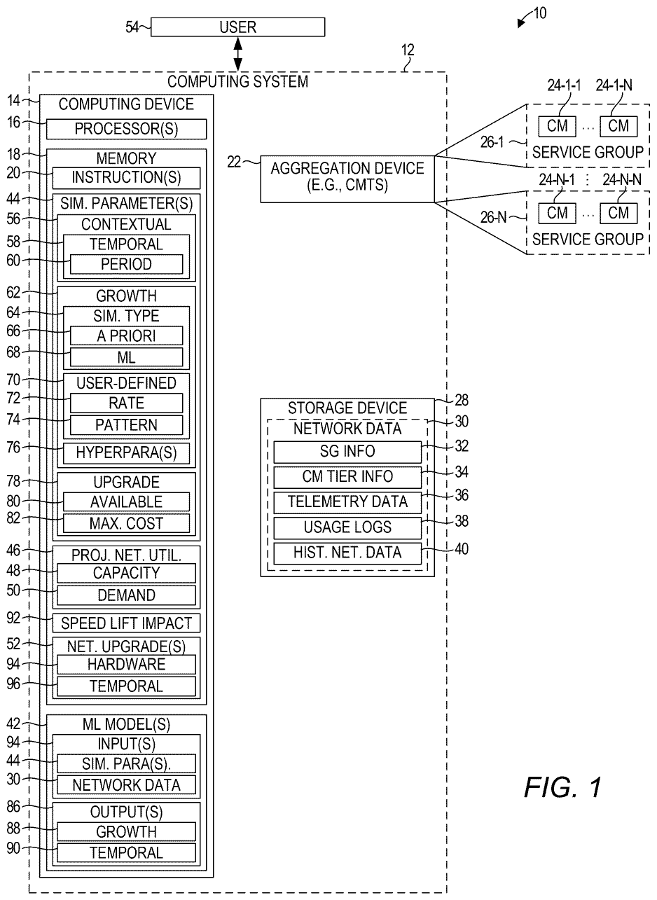

FIG. 1 is a block diagram of an environment 10 suitable for implementing network-forecasting operations according to some implementations. The environment 10 includes a computing system 12. The computing system 12 includes one or more computing devices 14 that, together, form a service provider computing system/network. It should be understood that example aspects of the present disclosure are disclosed and/or depicted as being implemented by a single component on a single computing device of the computing system 12 for purposes of illustration and discussion. However, in some examples, the functionality described herein may be distributed across multiple components on multiple computing devices of the computing system 12.

The computing device 14 may include a processor device 16. The processor device 16 may include any computing or electronic device(s) capable of executing software instructions to implement the functionality described herein. For example, the processor device 16 may be one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The processor device 16 may be a single processor device and/or a plurality of processor devices that are operatively connected, for instance, in a parallel configuration.

The computing device 14 may further include a memory 18. The memory 18 may be communicatively coupled to the processor device 16. The memory 18 may include executable instructions 20 that, when executed, cause the processor device 16 to perform operations, such as any of the operations described herein. In some examples, the memory 18 includes a controller (not shown) operable to implement the functionality described herein. Because the controller (not shown) is a component of the computing system 12 and/or the computing device 14, functionality implemented by the controller (not shown) may be attributed to the computing system 12 and/or the computing device 14 generally. Moreover, in examples where the controller (not shown) includes software instructions (e.g., instructions 20) that program the processor device 16 to carry out the functionality described herein, functionality implemented by the controller (not shown) may be attributed to the processor device 16, the computing system 12, and/or to the computing device 14 generally.

The memory 18 may be or otherwise include any device(s) capable of storing data, including, but not limited to, volatile memory (random access memory, etc.), non-volatile memory, storage device(s) (e.g., hard drive(s), solid state drive(s), etc.). For example, the memory device 18 may include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the memory device 18 are not limited to the above description, and the memory device 18 may be realized by other various devices and structures as would be understood by those having ordinary skill in the art.

As will be discussed in greater detail below, the computing system 12 may also include additional storage device(s) and/or database(s) configured to store network-related data associated with the computing system 12.

The computing system 12 further includes a plurality of aggregation devices 22, such as, by way of non-limiting example, a plurality of cable modem termination systems (CMTSs) and/or the like. It should be understood that the computing system 12 may include any suitable aggregation device without deviating from the scope of the present disclosure. Furthermore, for purposes of simplicity and explanation, only one aggregation device 22 is depicted in FIG. 1. However, those having ordinary skill in the art will understand that the computing system 12 may include any number of aggregation devices 22 without deviating from the scope of the present disclosure.

The aggregation device 22 communicates with thousands or tens of thousands of cable modems 24-1-1-24-1-N and 24-N-1-24-N-N (generally, “cable modems 24”) that are located in subscribers' premises, such as houses or offices. The aggregation device 22 also communicates with upstream computing devices (not illustrated) in the service provider network (e.g., computing system 12) to facilitate communications between the cable modems 24 and other networks, such as the Internet.

The aggregation device 22 implements a plurality of service groups 26-1-26-J (collectively, “service groups 26”). The cable modems 24-1-1-24-1-N are in the service group 26-1, and the cable modems 24-N-1-24-N-N are in the service group 26-N. Each service group 26 has an associated maximum bandwidth allocated to the service group 26. Each cable modem 24 in a service group 26 shares the same group of channels and thus shares the aggregate bandwidth of the service group 26.

Each cable modem 24 has an associated service tier that is typically based on a pricing structure implemented by the service provider. The service tier is in essence a speed tier because the service tier identifies a maximum instantaneous bandwidth for each respective cable modem 24. For example, a first subset of cable modems 24 (e.g., first plurality of cable modems 24) in the service group 26-1 may be in a 1 Gbps service tier and is thus provisioned to obtain a maximum bandwidth of 1 Gbps. A second subset of cable modems 24 in the service group 26-1 (e.g., second plurality of cable modems 24) may be provisioned with a 600 Mbps service tier, and another subset of cable modems 24 in the service group 26-1 may be provisioned with a 200 Mbps service tier. There may be any number of service tiers in a service group 26.

Table 1 below provides an example of the number of cable modems 24 and corresponding service tiers (also referred to herein as speed tiers).

TABLE 1

| SPEED TIER | | |
|---|---|---|
| (DOWNSTREAM IN MBPS) | N MODEMS | WEIGHT |
| 20 | 5 | 4 |
| 30 | 4 | 5 |
| 60 | 15 | 7 |
| 100 | 19 | 10 |
| 200 | 12 | 15 |
| 300 | 206 | 17 |
| 400 | 124 | 20 |
| 600 | 3 | 24 |
| 1000 | 11 | 30 |

Changes to a service group 26 to increase capacity or change (e.g., reduce) the group of cable modems 24 serviced by the service group 26 require physical changes to the aggregation device 22. Accordingly, a technician must be dispatched to the location of the aggregation device 22 if such a change to a service group 26 is desired. This process is relatively costly and time-consuming, and thus it is preferable to change a service group 26 only when necessary to provide adequate service to the group of cable modems 24 in the service group 26.

In practice, the cable modems 24 in a service group 26 do not simultaneously attempt to obtain the entire provisioned bandwidth, and thus the configured maximum capacity of a service group 26 is typically less than the sum of the provisioned service tiers of each of the cable modems 24 in the service group 26. However, at times, a sufficient number of cable modems 24 in the service group 26 may attempt to concurrently utilize their allocated maximum bandwidth that the concurrent demand may exceed the configured maximum capacity of the service group 26. If this happens frequently, this may lead to customer dissatisfaction. However, the likelihood that a cable modem 24 cannot obtain the maximum provisioned bandwidth differs depending on the service tier.

For instance, a cable modem 24 provisioned with a 1 Gbps service tier is more likely to be unable to obtain the maximum provisioned bandwidth than a cable modem 24 provisioned with a 100 Mbps service tier simply because the cable modem 24 provisioned with a 1 Gbps service needs 10 times the bandwidth of the cable modem 24 provisioned with the 100 Mbps service tier. Moreover, the number of cable modems 24 in each service tier may widely differ for a particular service group 26 and may widely differ across different service groups 26. Because of complexity and a number of variables, a service provider may simply wait until a sufficient number of customers complain that they are not obtaining the bandwidth they are entitled to before the service provider decides to alter the service group 26. Unfortunately, at that point, multiple customers may be dissatisfied, which can lead to customer loss.

There is typically a long-term utilization trend of a service group 26 wherein the utilization of the service group 26 by the cable modems 24 varies over time. For example, over a nine-month period, the utilization of the service group 26-1 may generally increase, or the utilization of the service group 26-1 may generally decrease. There are also short-term conditions that may cause significant variations in the utilization of the service group 26-1. As examples, during evening hours the service group 26-1 may generally have a greater utilization than during early morning hours. On Sundays, the service group 26-1 may have a greater utilization than on Wednesdays. These variations may differ from service group 26 to service group 26. For example, the cable modems 24 in a first service group 26 may be used by a neighborhood of football fans who view many football games on Sundays, driving utilization of the first service group 26 upward. The cable modems 24 in a second service group 26 may be used by a neighborhood of non-football fans such that there is no spike in utilization of the second service group 26 on Sundays.

In this multi-variable environment, there are heavy-utilization instants in time when a cable modem 24 cannot be provided the complete bandwidth of the service tier in which the cable modem 24 is provisioned because doing so would require more capacity than the service group 26 has at that instant in time. The greater the bandwidth of the service tier, the more likely it is that a cable modem 24 may not be able to be provided the compete bandwidth. While this may be acceptable when such instants in time are rare, as utilization of a service group generally increases the inability to obtain the provisioned bandwidth may occur frequently enough to lead to customer dissatisfaction. However, due to the multiple variables that effect utilization at any given instant in time, as discussed above, it is difficult or impossible to predict how often a cable modem 24 may not be able to be provided the complete bandwidth that the cable modem 24 is supposed to be provided.

The examples disclosed herein implement mechanisms determining the extent to which the network utilization of each service group 26 will change over a period of time and, based on the determined changes, what network upgrades (e.g., to the network infrastructure of the computing system 12) are needed to maintain a satisfactory network capacity.

As noted above, the computing system 12 may include additional data stores, such as the storage device 28. The storage device 28 may be any suitable storage device, such as a data store, a database, and/or the like. As shown in FIG. 1, the storage device 28 may be configured to store network data 30 associated with the computing system 12. By way of non-limiting example, the storage device 28 may store service group information 32 that identifies the service groups 26 serviced by the aggregation device 22. The service group information 32 may also identify the cable modems 24 in each service group 26. The storage device 28 may also store cable modem tier information 34 that identifies, for each cable modem 24, the service tier (e.g., speed tier) of the cable modem 24.

The network data 30 may further include telemetry data 36. More particularly, telemetry data 36 may be collected and stored on the storge device 28 on an ongoing basis. The telemetry data 36 may include aggregate service group utilization values that identify aggregate service group bandwidth utilization at a particular instant in time for each service group 26. The aggregate service group utilization values may be taken at a periodic interval, such as each hour, each ½ hour, each 15 minutes, or the like. The telemetry data 36 may be collected and stored for any desired period of time such as months or years. In some examples, the telemetry data 36 may be generated by a telemetry agent (not shown) executing on the aggregation device 22. For instance, the telemetry agent (not shown) may be configured to determine the instantaneous aggregate service group utilization at the desired interval and to send the instantaneous aggregate service group utilization to the controller (not shown) or another component for storage in the storage device 28 (e.g., in the telemetry data 36).

The network data 30 stored in the storage device 28 may also store other data associated with the computing system 12, such as usage logs 38 and historical network data 40. As discussed in greater detail below, the usage logs 38 may be data that characterizes various interactions between each cable modem 24 of each service group 26 and the computing system 12. The historical network data 40 may be data characterizing network performance associated with the computing system 12, such as capacity metrics (e.g., network capacity, buffer capacity, etc.), utilization metrics (e.g., network utilization, service group utilization, cable modem utilization, etc.), performance metrics (e.g., latency, jitter, packet loss, etc.), network traffic metrics (e.g., traffic volume, throughput, etc.), reliability metrics (e.g., transmission error rate, network availability, etc.), and/or the like.

It should be understood that the network data 30 stored in the storage device 28 may include any suitable data associated with the computing system 12 and its various components (e.g., cable modems 24, service group 26, etc.).

The computing system 12 may further include one or more machine-learned models 42 (hereinafter, “machine-learned model 42”). In some examples, the network data 30 and/or other data associated with the computing system 12 may be provided as training data to the machine-learned model 42. It should be understood that, although only one machine-learned model 42 is depicted in FIG. 1, the computing system 12 may be configured to leverage distributed computing architecture(s) to train, generate, implement, etc. multiple models in parallel, thereby reducing the time, computing and/or processing resources, memory, etc. associated with performing the network-forecasting operations described herein.

As described herein, the machine-learned model 42 may be and/or may include a time-series forecasting model configured to implement the network-forecasting operations described herein for the computing system 12, the service groups 26, the cable modems 24, and/or the like. It should be understood that the machine-learning model 42 may be any suitable machine-learning model, such as a neural network (e.g., deep neural network, feed-forward neural network, recurrent neural network, convolutional neural network, etc.) and/or other types of machine-learning models (e.g., non-linear models, linear models, etc.). In some examples, the machine-learning model 42 may be trained using an unsupervised training algorithm (e.g., K-means, hierarchical clustering, etc.) to refine the machine-learning model 42 and its corresponding outputs.

With this background, example aspects of the present disclosure are directed to systems, methods, frameworks, etc. for performing network-forecasting operations that provide on-demand network-utilization projections and corresponding network upgrades (e.g., to network infrastructure) based on the network-utilization projections for the computing system 12. That is, the computing system 12 may be configured to execute sophisticated network simulations that leverage data-based forecasting frameworks to generate network upgrades for the computing system 12.

As a general overview, the computing system 12 may execute the network simulations in the form of discrete scenarios, which are defined by a plurality of simulation parameters 44 (generally, “simulation parameters 44”) that establish the scope, constraints, contingencies, etc. of the scenario. Once the particular scenario is defined (e.g., by the simulation parameters 44), the computing system 12 may obtain (e.g., query) the network data 30 to determine a current network state. That is, the computing system 12 may query the network data 30 to determine, e.g., an existing network capacity and/or existing network utilization for each service group 26 included in the particular scenario (e.g., as defined by the simulation parameters 44). Based on the network data 30 and the simulation parameters 44, the computing system 12 may determine a projected network utilization 46 that characterizes a forecasted network capacity 48 and an expected customer demand 50 for the corresponding service group 26. Based on the projected network utilization 46 and the simulation parameters 44, the computing system 12 may then generate one or more network upgrade(s) 52 (generally, “network upgrade 52”) for the computing system 12 that are configured to provide the forecasted network capacity 48 to the corresponding service group 26.

The network-forecasting operations of the present disclosure are discussed in greater detail below.

As noted above, the computing system 12 may execute the network simulations in the form of discrete scenarios that are defined by the simulation parameters 44. More particularly, the computing system 12 may obtain the simulation parameters 44, which define the scope of the scenario and the constraints and/or contingencies that the computing system 12 considers during execution of the scenario.

For instance, in some examples, the simulation parameters 44 may include contextual parameters 56 that define the scope, assumptions, etc. for the simulation scenario implemented by the computing system 12. By way of non-limiting example, the contextual parameters 56 may include temporal parameters 58 that define a simulation time period 60 (e.g., the time length of the simulation scenario). The contextual parameters 56 may further include parameters that define the dates the computing system 12 is to consider when assessing the current state of the computing system 12, such as the current rates of service group-level utilization and available capacity for each service group 26 and/or the like. In some examples, contextual parameters 56 may further include parameters defining at least one service group 26 (or more) for which the simulation scenario is implemented. In some examples, contextual parameters 56 may further include data defining a data transmission direction (e.g., upstream, downstream). That is, the contextual parameters 56 may include data defining whether the computing system 12 is to evaluate upstream utilization and capacity and/or downstream utilization and capacity. In some examples, the contextual parameters 56 may further include data defining whether the computing system 12 is to consider a hypothetical service-tier lift (e.g., speed lift) in its simulation scenario. Service-tier lifts (e.g., speed lifts) are discussed in greater detail below.

The simulation parameters 44 may also include growth parameters 62 that define how the computing system 12 determines the expected future utilization (e.g., projected network utilization 46) for the particular scenario. By way of non-limiting example, the growth parameters 62 may include a simulation-type parameter 64 that defines whether the simulation scenario implemented by the computing system 12 is based on a priori hypothetical specifications 66 and/or based on machine-learning model-based specifications 68. The growth parameters 62 may further include additional specifications based on the type of simulation scenario identified by simulation-type parameter 64. More particularly, in examples where the simulation scenario implemented by the computing system 12 is based on a priori hypothetical specifications 66, the growth parameters 62 may include a user-defined growth parameter 70 that defines an a priori growth function, including a growth rate 72 and a growth pattern 74 (e.g., linear growth pattern, exponential growth pattern, etc.). Additionally and/or alternatively, in examples where the simulation scenario implemented by the computing system 12 is based on machine-learning model-based specifications 68, the growth parameters 62 may include hyperparameters 76 and/or other suitable configuration parameters for the machine-learned model 42.

The simulation parameters 44 may further include upgrade parameters 78 that define the type, scope, etc. of network configurations considered by the computing system 12 while implementing the simulation scenario. By way of non-limiting example, the upgrade parameters 78 may include an upgrade-type parameter 80 that defines a plurality of available network upgrades that may be considered for deployment by the computing system 12 during the simulation scenario. The upgrade parameters 78 may further include a maximum-cost parameter 82 that defines a fiscal constraint (e.g., maximum cost, range of costs, etc.) for the potential network upgrades. The upgrade parameters 78 may also include other performance-related parameters for the potential network upgrades, such as, by way of non-limiting example, a minimum buffer capacity, a minimum network capacity, and/or the like.

Once the particular scenario is defined, the computing system 12 may obtain network data associated with the computing system 12, such as the network data 30. The computing system 12 may obtain some, or all, of the network data 30 depending on the scope of the scenario as defined by the simulation parameters 44. For instance, in some examples, the computing system 12 may query the network data 30 from the storage device 28 to determine current network utilization levels, existing network capacity, etc. for each service group 26 included in the simulation scenario (e.g., as defined by the simulation parameters 44). Although not depicted in FIG. 1, in some examples, the computing system 12 may query other network-related data from other computing systems (not shown). Additionally and/or alternatively, in some examples, the computing system 12 may perform additional data-processing operations on the network data 30, such as, by way of non-limiting example, data transformation operations, data-summarization operations, training data-generation operations, and/or the like.

As noted above, the computing system 12 may determine a projected network utilization 46 for the at least one service group 26 identified by the simulation parameters 44 based on the network data 30 and the type of simulation identified by the simulation parameters 44. The projected network utilization 46 may characterize the forecasted network capacity 48 and expected customer demand 50 for the corresponding service group 26. As described herein, the computing system 12 may be configured to determine the projected network utilization 46 based on the a priori hypothetical specifications 66, the machine-learned model-based specifications 68, and/or any suitable combination thereof.

More particularly, in examples where the simulation parameters 44 include a priori hypothetical specifications 66, the computing system 12 may determine the projected network utilization 46 based on the user-defined growth parameter 70—including the growth rate 72 and the growth pattern 72—and the network data 30.

Additionally and/or alternatively, in examples where the simulation parameters 44 include machine-learning model-based specifications 68, the computing system 12 may determine the projected network utilization 46 by leveraging the machine-learned model 42. More particularly, the computing system 12 may provide the network data 30 associated with the at least one service group 26 and the simulation parameters 44 as inputs 84 to the machine-learned model 42; the computing system 12 may determine the projected network utilization 46 for the at least one service group 26 based on an output 86 of the machine-learned model 42.

In some examples, the output 86 of the machine-learned model 42 may include an overall growth component 88 and a temporal growth component 90. The overall growth component 88 may characterize a change in network utilization over the simulation time period 60 (e.g., a steady change rate). The temporal growth component 90 may characterize various network-utilization fluctuations over a portion of the simulation time period 60. That is, the temporal growth component 90 may characterize seasonal patterns, holiday-related patterns, etc. that result in atypical and temporally isolated network-utilization fluctuations. In this way, the projected network utilization 46 determined by the computing system 12 may provide an accurate representation of customer behavior over the simulation time period 60.

In some examples, the computing system 12 may enrich the machine-learned model 42 by providing at least one regressor to the machine-learned model 42 to enhance the quality, completeness, usefulness, etc. of the output 86. For instance, in some examples, the telemetry data 36 associated with the computing system 12 may be provided as a regressor to the machine-learned model 42. In some examples, the usage logs 38 associated with each of the service groups 26 may be provided as a regressor to the machine-learned model 42. It should be understood that any suitable regressor may be provided to the machine-learned model 42 without deviating from the scope of the present disclosure.

In some examples, the computing system 12 may be configured to perform and/or otherwise implement hierarchical time-series forecasting operations and algorithms to determine the projected network utilization 46 for the at least one service group 26. As described above, hierarchical time-series forecasting may be implemented by the computing system 12 to improve the network-utilization projections described herein, particularly in situations where service group-level data is noisy, limited, unavailable, etc.

More particularly, the computing system 12 may be configured to implement hierarchical time-series forecasting operations in situations where the projected network utilization 46—which characterizes the forecasted network capacity 48 and expected customer demand 50 at the service-group level—may be determined (e.g., inferred) based on similar aggregate network-utilization projections that characterize forecasted network capacity and expected customer demand at a higher and/or superordinate level. Put differently, because a projected network utilization for the aggregation device 22 is an aggregation of the projected network utilizations 46 for each of the service groups 26 serviced by the aggregation device 22, the computing system 12 may determine the projected network utilization 46 for each of the service groups 26 serviced by the aggregation device 22 by determining a relationship between each of the service groups 26 and the aggregation device 22.

For instance, suppose the service group 26-1 accounts for a particular percentage of the overall network utilization for the aggregation device 22. The computing system 12 may determine an aggregate projected network utilization for the aggregation device 22 which, like the (e.g., service-group level) projected network utilization 46, characterizes an aggregate forecasted network capacity and aggregate expected customer demand at the aggregation-device level. In such instances, the computing system 12 may determine the projected network utilization 46 for the service group 26-1 based on the relationship between the service group 26-1 and the aggregation device 22. That is, the computing system 12 may determine that the projected network utilization 46 for the service group 26-1 is approximately the same particular percentage of the aggregate projected network utilization for the aggregation device 22.

By way of non-limiting illustrative example, if the computing system 12 determines that a service group (e.g., service group 26-1) accounts for five percent (5%) of the overall network utilization of the aggregation device 22 (e.g., based on the network data 30), the computing system 12 may determine that the specific network utilization projection for that specific service group (e.g., service group 26-1) likewise accounts for approximately five percent (5%) of the aggregate projected network utilization of the aggregation device 22.

To implement the hierarchical time-series forecasting described herein, the computing system 12 may query the network data 30 (e.g., stored on the storage device 28) associated with a higher-level unit (e.g., aggregation device 22, DMA, etc.) relative to the cable modems 24 and/or the service groups 26, such as network data associated with the aggregation device 22 that services the at least one service group 26 identified by the simulation parameters 44. The computing system 12 may then determine an aggregate projected network utilization, which characterizes an aggregate forecasted network capacity for the plurality of service groups 26 serviced by the aggregation device 22, based on the network data associated with the aggregation device 22. The computing system 12 may then determine the projected network utilization 46 for the at least one service group 26 based on the simulation parameters 44 and the aggregate projected network utilization for the aggregation device 22.

The computing system 12 may also be configured to determine impacts associated with potential network-utilization shocks, such as hypothetical service-tier lifts (e.g., speed lifts). As described herein, a “service-tier lift” and/or “speed lift” refers to a situation in which customers at a lower service tier and “lifted” to a higher service tier. In other words, a “service-tier lift” and/or “speed lift” occurs when a maximum allowed network-utilization rate for one set of customers within a service group 26 is increased.

The computing system 12 may be configured to determine a projected speed-lift impact 92 associated with increasing the service tier of the service group 26. Furthermore, the computing system 12 may incorporate the speed-lift impact 92 into the corresponding projected network utilization 46 determination for the service group. In this manner, the computing system 12 is configured to account for potential service-tier lifts in its determination of projected network utilizations 46 without having to forecast and/or determine multiple additional values (e.g., separately from the projected network utilization 46), thereby reducing the computational and processing requirements needed for such determinations.

As noted above, in some examples, the simulation parameters 44 (e.g., contextual parameters 56) may include data defining whether the computing system 12 is to consider a hypothetical service-tier lift in simulation scenario. In examples where the simulation parameters 44 do indicate that the hypothetical service-tier lift is to be considered, the computing system 12 may determine the projected speed-lift impact 92 for the at least one service group 26 based on the network data 30. In such examples, the computing system 12 may determine the projected network utilization 46 for the at least one service group 26 based on the simulation parameters 44 and the projected speed-lift impact 92. For instance, by way of non-limiting example, the service group 26-1 may include a first plurality of cable modems 24 and a second plurality of cable modems 24. As described herein, the first plurality of cable modems 24 may be provisioned at a first service tier, and the second plurality of cable modems 24 may be provisioned at a second service tier. The second service tier may include a greater bandwidth relative to the first service tier. In such examples, the projected speed-lift impact 92 may be associated with reprovisioning the first plurality of cable modems 24 at the second service tier.

As described herein, the computing system 12 may generate a network upgrade 52 based on the projected network utilization 46 and the simulation parameters 44 (e.g., the upgrade parameters 78). The network upgrade 52 may be provided to the user 54 and/or otherwise implemented in any suitable manner. The network upgrade 52 may be configured to provide the forecasted network capacity 48 to the at least one service group 26.

In some examples, the network upgrade 52 may include a hardware component 94 and a temporal component 96. The hardware component 94 may identify at least one hardware upgrade to existing network infrastructure associated with the at least one service group 26, such as an upgrade to the aggregation device 22 and/or the like. The temporal component 96 may identify a future period of time in which the network upgrade 52 is to be implemented to provide the forecasted network capacity 48 to the at least one service group 26.

For instance, as noted above, the computing system 12 may determine the expected customer demand 50 for the at least one service group 26 over the simulation time period 60 based on the network data 30 and the simulation parameters 44. Based on the expected customer demand 50, the computing system 12 may determine that the forecasted network capacity 48 exceeds an existing network capacity of the computing system 12 (e.g., for the service group 26 based on the historical network data 40). The computing system 12 may then generate the network upgrade 52 for the at least one service group 26 based on the forecasted network capacity 48 and the simulation parameters 44 (e.g., upgrade parameters 78). The network upgrade 52 may be a network-infrastructure upgrade that is configured to increase the existing network capacity of the computing system 12 (e.g., for the service group 26) to the forecasted network capacity 48. Additionally, the network upgrade 52 may be a network-infrastructure upgrade that is configured to provide the minimum buffer capacity, minimum network capacity, and/or the like to the service group 26.

For instance, in some examples, the computing system 12 may identify at least one of the plurality of available network upgrades 80 as an eligible network upgrade based on the forecasted network capacity 48 and the maximum-cost parameter 82. In such examples, the computing system 12 may generate the network upgrade 52 for the at least one service group 26 based on the identified eligible network upgrade. Additionally and/or alternatively, in some examples, the computing system 12 may generate a plurality of network upgrades 52. Each of the plurality of network upgrades 52 may be different relative to one another and may be configured to provide the forecasted network capacity 48 to the at least one service group 26. In this manner, the computing system 12 may provide the user 54 with a plurality of options for providing the forecasted network capacity 48 to the at least one service group 26.

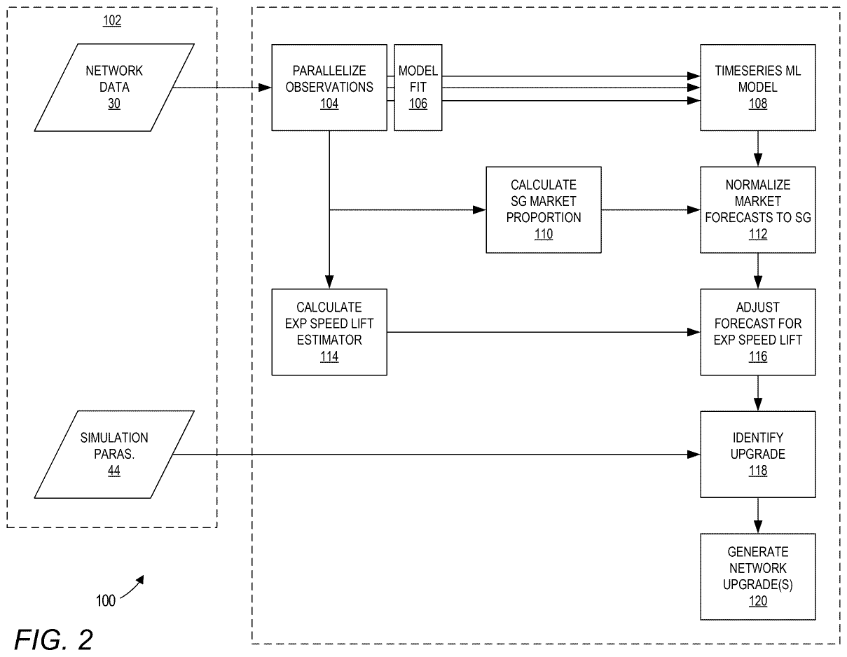

FIG. 2 depicts a process flow diagram of an example framework 100 suitable for implementing network-forecasting operations according to some implementations. FIG. 2 will be discussed in conjunction FIG. 1. It should be understood that, in the example depicted in FIG. 2, the computing system 12 implements a simulation scenario based on machine-learned model-based specification 68.

The computing system 12 obtains and provides input data (e.g., network data 30, simulation parameters 44, etc.) to the framework 100 (FIG. 2, step 102). The computing system 12 leverages a distributed computing architecture to implement a plurality of parallel instances of the machine-learning model 42 (FIG. 2, step 104). The computing system 12 partitions the input data (e.g., network data 30) and fits the machine-learned model 42 by aggregation level (e.g., by aggregation device 22, by DMA, etc.) to implement a hierarchical forecasting algorithm (FIG. 2, step 106). The computing system 12 provides the partitioned input data (e.g., network data 30 partitioned by aggregation level) to parallel instances of the machine-learned model 42 (FIG. 2, step 108).

The computing system 12 determines a relationship between each lower-level unit (e.g., service groups 26) and the corresponding higher-level unit (e.g., aggregation device 22, DMA, etc.) (FIG. 2, step 110). The computing system 12 determines a higher-level forecast (e.g., aggregate projected network utilization) for each higher-level unit (e.g., aggregation device 22, DMA, etc.) and normalizes the higher-level forecasts to each lower-level unit (e.g., service group 26) (FIG. 2, step 112).

The computing system 12 determines a projected speed-lift impact 92 based on the input data (e.g., simulation parameters 44) (FIG. 2, step 114) and determines the projected network utilization 46 for each lower-level unit (e.g., service group 26) based on the input data (e.g., network data 30, simulation parameters 44) and the projected speed-lift impact 92 (FIG. 2, step 116).

The computing system 12 identifies at least one of the plurality of available network upgrades 80 (e.g., defined in the upgrade parameters 78) as an eligible network upgrade based on the simulation parameters 44 (e.g., contextual parameters 56, growth parameters 62, upgrade parameters 78, etc.) and the projected network utilization 46 (e.g., based on the forecasted network capacity 48) (FIG. 2, step 118). The computing system 12 generates network upgrade(s) 52—including a corresponding hardware component 94 and temporal component 96—for each lower-level unit (e.g., service group 26) based on the eligible network upgrade(s) (FIG. 2, step 120).

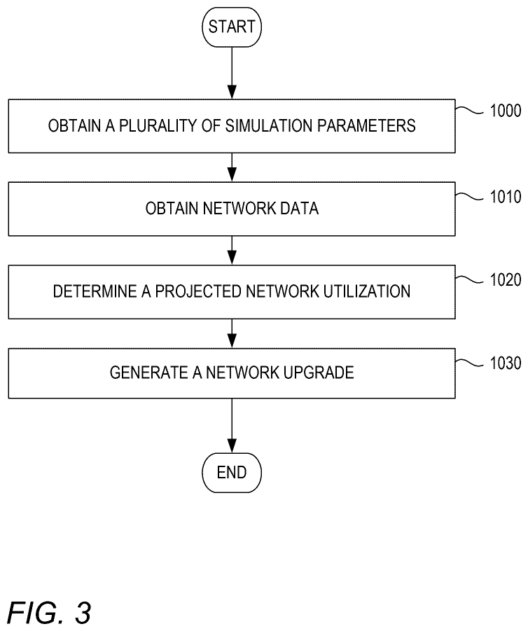

FIG. 3 depicts a flowchart of an example network-forecasting method according to some implementations. FIG. 3 will be discussed in conjunction with FIG. 1. The computing system 12 obtains a plurality of simulation parameters 44 that identify at least one service group 26-1-26-N of a plurality of service groups 26 serviced by the computing system 12 (FIG. 3, block 1000). The computing system 12 obtains network data 30 associated with the computing system 12 (e.g., from storage device 28) based on the plurality of simulation parameters 44 (FIG. 3, block 1010). The computing system 12 determines a projected network utilization 46 (e.g., characterizing a forecasted network capacity 78) for the at least one service group 26-1-26-N based on the plurality of simulation parameters 44 and the network data 30 (FIG. 3, block 1020). The computing system 12 generates a network upgrade 52, which is configured to provide the forecasted network capacity 48, for the at least one service group 26-1-26-N based on the projected network utilization 46 and the plurality of simulation parameters 44 (FIG. 3, block 1030).

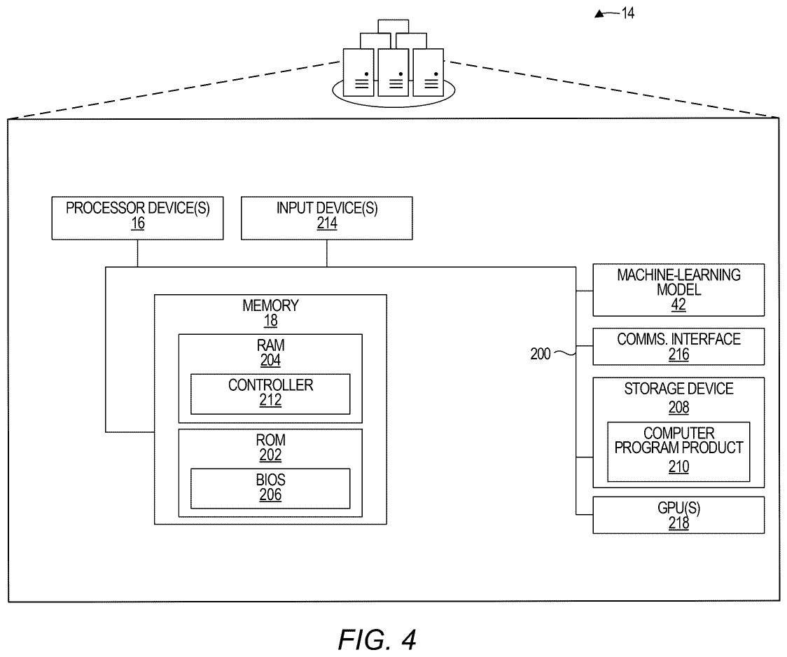

FIG. 4 depicts a block diagram of an example computing device of the computing system 12 (e.g., described above with reference to FIGS. 1-3), such as the computing device 14, suitable for implementing examples disclosed herein according to some implementations. The computing device 14 may be any suitable computing device operable to perform the network-forecasting operations described herein.

The computing device 14 may include any computing and/or electronic device capable of including firmware, hardware, and/or executing software instructions to implement the functionality described herein, such as a computer server, computing device, and/or the like. The computing device 14 includes processor device(s) 16, a system memory (e.g., memory 18), and a system bus 200. The system bus 200 provides an interface for system components including, but not limited to, the memory 18 and the processor device 16. The processor device(s) 16 may be any commercially available or proprietary processor.

The system bus 200 may be any of several types of bus structures that may further interconnect to a memory bus (with or without a memory controller), a peripheral bus, and/or a local bus using any of a variety of commercially available bus architectures. The memory 18 may include non-volatile memory 202 (e.g., read-only memory (ROM), erasable programmable read-only memory (EPROM), electrically erasable programmable read-only memory (EEPROM), etc.), and volatile memory 204 (e.g., random-access memory (RAM)). A basic input/output system (BIOS) 206 may be stored in the non-volatile memory 202 and may include the basic routines that help to transfer information between elements within the computing device 14. The volatile memory 204 may also include a high-speed RAM, such as static RAM, for caching data.

The computing device 14 may further include or be coupled to a non-transitory computer-readable storage medium, such as a storage device 208, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 208 and other drives associated with computer-readable media and computer-usable media may provide non-volatile storage of data, data structures, computer-executable instructions, and the like.

A number of modules can be stored in the storage device 208 and in the volatile memory 204, including an operating system and one or more program modules, which may implement the functionality described herein in whole or in part. All or a portion of the examples may be implemented as a computer program product 210 stored on a transitory or non-transitory computer-usable or computer-readable storage medium, such as the storage device 208, which includes complex programming instructions, such as complex computer-readable program code, to cause the processor device 16 to carry out the steps described herein. Thus, the computer-readable program code may comprise software instructions for implementing the functionality of the examples described herein when executed on the processor device 16. The processor device 16, in conjunction with a controller 212 in the volatile memory 204, may serve as a controller and/or or a control system for the computing device 14 that is to implement the functionality described herein.

An operator (e.g., user) may also be able to enter one or more configuration commands through one or more input device(s) 214, such as a keyboard (not illustrated), a pointing device such as a mouse (not illustrated), or a touch-sensitive surface such as a display device. Such input devices 214 may be connected to the processor device 16 through an input interface (not shown) coupled to the system bus 200 but can be connected through other interfaces such as a parallel port, an Institute of Electrical and Electronic Engineers (IEEE) 1394 serial port, a Universal Serial Bus (USB) port, an IR interface, and/or the like.

The computing device 14 may also include a number of communication interfaces, such as communication interface 216, that are suitable for communicating with a network (or devices connected thereto) as appropriate or desired. The computing device 14 may further include one or more GPUs 218.

In some examples, the computing device 14 may further include the machine-learning model 42. Although not depicted as such in FIG. 4, the machine-learning model 42 may be stored in the memory 18, the storage device 208, and/or the like. The computing device 14 may be configured to determine a projected network utilization 46 (not shown) and/or generate network upgrades 52 (not shown) based on the output 86 (not shown) of the machine-learning model 42. The machine-learning model 42 may be any suitable machine-learning model, such as, by way of non-limiting example, a neural network (e.g., deep neural network, feed-forward neural network, recurrent neural network, convolutional neural network, etc.) and/or other types of machine-learning models (e.g., non-linear models, linear models, etc.). In some examples, the machine-learning model 42 may be trained using an unsupervised training algorithm (not shown) (e.g., K-means, hierarchical clustering, etc.) to refine the machine-learning model 42 and its corresponding outputs.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a computing system, a plurality of simulation parameters, the plurality of simulation parameters identifying at least one service group of a plurality of service groups serviced by the computing system;
obtaining, by the computing system, network data associated with the computing system based on the plurality of simulation parameters;
determining, by the computing system, a projected network utilization for the at least one service group based on the plurality of simulation parameters and the network data, the projected network utilization characterizing a forecasted network capacity for the at least one service group; and
generating, by the computing system, a network upgrade for the at least one service group based on the projected network utilization and the plurality of simulation parameters, the network upgrade configured to provide the forecasted network capacity to the at least one service group.

2. The method of claim 1, wherein determining the projected network utilization for the at least one service group comprises:
providing, by the computing system, the network data associated with the at least one service group and the plurality of simulation parameters to a machine-learned model of the computing system; and
determining, by the computing system, the projected network utilization for the at least one service group based on an output of the machine-learned model.

3. The method of claim 2, wherein the machine-learned model is a time-series forecasting model.

4. The method of claim 2, wherein the output of the machine-learned model comprises:
an overall growth component characterizing a change in network utilization over a simulation time period, the simulation time period defined by the plurality of simulation parameters; and
a temporal growth component characterizing a network-utilization fluctuation over a portion of the simulation time period.

5. The method of claim 2, further comprising:
providing, by the computing system to the machine-learned model, at least one regressor to enrich the machine-learned model,
wherein the at least one regressor comprises one or more of:
telemetry data associated with the computing system; and
usage logs associated with each of the plurality of service groups.

6. The method of claim 2, further comprising:
providing, by the computing system to the machine-learned model, historical network data associated with the computing system as training data for the machine-learned model.

7. The method of claim 2, wherein the computing system comprises a distributed computing architecture configured to implement a plurality of machine-learned models in parallel.

8. The method of claim 1, wherein obtaining the network data associated with the computing system comprises:
obtaining, by the computing system, network data associated with an aggregation device, the aggregation device configured to implement the plurality of service groups.

9. The method of claim 8, wherein determining the projected network utilization for the at least one service group comprises:
determining, by the computing system, an aggregate projected network utilization for the aggregation device based on the network data associated with the aggregation device, the aggregate projected network utilization characterizing an aggregate forecasted network capacity for the plurality of service groups serviced by the aggregation device; and
determining, by the computing system, the projected network utilization for the at least one service group based on the plurality of simulation parameters and the aggregate projected network utilization for the aggregation device.

10. The method of claim 1, wherein the at least one service group services a plurality of cable modems, each cable modem being provisioned based on a service tier that identifies a maximum instantaneous bandwidth for each respective cable modem of the computing system.

11. The method of claim 10, wherein the plurality of cable modems comprises a first plurality of cable modems and a second plurality of cable modems, the first plurality of cable modems being provisioned at a first service tier and the second plurality of cable modems being provisioned at a second service tier, the second service tier comprising a greater bandwidth relative to the first service tier.

12. The method of claim 11, wherein determining the projected network utilization for the at least one service group comprises:
determining, by the computing system, a projected speed-lift impact for the at least one service group based on the network data, the projected speed-lift impact associated with reprovisioning the first plurality of cable modems at the second service tier; and
determining, by the computing system, the projected network utilization for the at least one service group based on the plurality of simulation parameters and the projected speed-lift impact.

13. The method of claim 1, wherein at least one of the plurality of simulation parameters comprises a user-defined growth parameter, and wherein determining the projected network utilization for the at least one service group comprises:
determining, by the computing system, the projected network utilization for the at least one service group based on the user-defined growth parameter and the network data.

14. The method of claim 13, wherein the user-defined growth parameter characterizes a growth rate and a growth pattern, the growth pattern being one of:
a linear growth pattern; or
an exponential growth pattern.

15. The method of claim 1, wherein the plurality of simulation parameters comprises a temporal parameter defining a simulation time period, and wherein generating the network upgrade for the at least one service group comprises:
determining, by the computing system, an expected customer demand for the at least one service group over the simulation time period based on the plurality of simulation parameters and the network data;
determining, by the computing system, that the forecasted network capacity exceeds an existing network capacity of the computing system based on the expected customer demand; and
generating, by the computing system, the network upgrade for the at least one service group based on the forecasted network capacity and the plurality of simulation parameters, the network upgrade configured to increase the existing network capacity to the forecasted network capacity.

16. The method of claim 15, wherein the plurality of simulation parameters further comprises a maximum-cost parameter defining a fiscal constraint for the network upgrade and an upgrade-type parameter defining a plurality of available network upgrades, and wherein generating the network upgrade for the at least one service group further comprises:
identifying, by the computing system, at least one of the plurality of available network upgrades as an eligible network upgrade based on the forecasted network capacity and the maximum-cost parameter; and
generating, by the computing system, the network upgrade for the at least one service group based on the eligible network upgrade.

17. The method of claim 15, wherein the network upgrade comprises a hardware component and a temporal component, and wherein:
the hardware component identifies at least one hardware upgrade to existing network infrastructure associated with the at least one service group; and
the temporal component identifies a future period of time at which the network upgrade is to be implemented to provide the forecasted network capacity to the at least one service group.

18. The method of claim 1, wherein generating the network upgrade for the at least one service group comprises:
generating, by the computing system, a plurality of network upgrades for the at least one service group based on the projected network utilization and the plurality of simulation parameters, each network upgrade of the plurality of network upgrades being different relative to one another, each network upgrade of the plurality of network upgrades configured to provide the forecasted network capacity to the at least one service group.

19. A computing system, comprising:
one or more computing devices operable to:
obtain a plurality of simulation parameters, the plurality of simulation parameters identifying at least one service group of a plurality of service groups serviced by the computing system;
obtain network data associated with the computing system based on the plurality of simulation parameters;
determine a projected network utilization for the at least one service group based on the plurality of simulation parameters and the network data, the projected network utilization characterizing a forecasted network capacity for the at least one service group; and
generate a network upgrade for the at least one service group based on the projected network utilization and the plurality of simulation parameters, the network upgrade configured to provide the forecasted network capacity to the at least one service group.

20. A non-transitory computer-readable medium that includes executable instructions configured to cause a processor device of a computing system to:
obtain a plurality of simulation parameters, the plurality of simulation parameters identifying at least one service group of a plurality of service groups serviced by the computing system;
obtain network data associated with the computing system based on the plurality of simulation parameters;
determine a projected network utilization for the at least one service group based on the plurality of simulation parameters and the network data, the projected network utilization characterizing a forecasted network capacity for the at least one service group; and
generate a network upgrade for the at least one service group based on the projected network utilization and the plurality of simulation parameters, the network upgrade configured to provide the forecasted network capacity to the at least one service group.
